(19) United States
(12) Patent Application Publication
(10) Pub. No.: US 2011/0128850 A1
(43) Pub. Date: Jun. 2, 2011

(54) BAND CONTROL SYSTEM, LOAD DISTRIBUTION DEVICE AND BAND CONTROL DEVICE

(76) Inventors: Ryo IIZAWA, Kawasaki (JP); Yuudai Ishikawa, Tokyo (JP); Takahiro Ogawa, Yokohama (JP)

(21) Appl. No.: 12/868,197

(22) Filed: Aug. 25, 2010

(30) Foreign Application Priority Data
Nov. 27, 2009 (JP) 2009-269818

(51) Int. Cl. H04L 12/26

(52) U.S. Cl. 370/235

(57) ABSTRACT

Band control is conducted for each user by distributing traffic for each user in a case where a plurality of band control devices are required due to increased traffic and under the condition where the user uses a plurality of terminals or has a plurality of IP addresses with one terminal to generate a plurality of communications at the same time. The band control is performed for each user, using a load distribution device for specifying a user identifier such as a contractor number or telephone number from the source IP address used by the users in making the communication, and transferring the traffic based on the user identifier, a user management device for managing the correspondence between the user identifier and the source IP address, and a plurality of band control devices for managing the traffic for each user identifier, and making the band control of traffic for each user through a transparent process installed on the network path and not recognized by the originator and recipient of the communication.

### CLAIM OF PRIORITY

The present application claims priority from Japanese patent application JP 2009-269818 filed on Nov. 27, 2009, the content of which is hereby incorporated by reference into this application.

### BACKGROUND OF THE INVENTION

1. Field of the Invention

The present invention relates to a band control system, a load distribution device and a band control device, and more particularly to a band control system, a load distribution device and a band control device in which traffic subject to an internet connection service with a mobile terminal or the like is controlled in distributed band for each user.

2. Description of the Related Art

In recent years, with the development and spread of an internet technique and a mobile communication technology, the amount of network traffic increases.

As the number of users using the network increases, there occur differences in the use frequency of the users, and the traffic of partial heavy user with high use frequency occupies the network facilities such as a radio base station and a router, so that the fairness in the use of network facilities with other general users may not be kept in some cases.

To solve such cases, there is a band control device for suppressing the traffic use of the heavy user.

With the conventional method (Nikkei NETWORK, September 2003, Page 72), there is provided a method for classifying the traffic of the user in units of the band control devices and managing the band according to classification.

Also, with another conventional method (Nikkei Communication, Apr. 15, 2008, Pages 52 to 56), there is provided a method for managing the band for each user in units of the band control devices.

For a load distribution method for band control, with the conventional method (JP-A-2009-175889), there is provided a method for distributing the traffic on a service basis in accordance with the number and performance of servers for processing the traffic.

### SUMMARY OF THE INVENTION

The related arts in the background of the invention have the following problems.

For example, in a case where a plurality of band control devices are required due to increased traffic, it is supposed that the user uses a plurality of terminals or has a plurality of IP addresses with one terminal to generate a plurality of communications at the same time. Under such a condition, with the conventional method, the band control is only allowed in units of the band control devices, whereby if the user uses a plurality of band control mechanisms at the same time, there is a problem that the band control can not be made for each user with the plurality of band control devices integrated.

With the conventional method (Nikkei NETWORK, September 2003, Page 72), the fairness may often lack among the users classified as the heavy user. With the conventional method (Nikkei Communication, Apr. 15, 2008, Pages 52 to 56), the fairness may also often lack if the traffic is distributed over the plurality of band control devices.

In the light of the above-mentioned problems, it is an object of the invention to allow the band control for each user by distributing the traffic for each user in a system having a plurality of band control devices.

In particular, the invention provides a method for making the band control for each user, using a plurality of band control devices.

More specifically, the invention realizes a network system, a load distribution device and a band control device that provide the following functions, for example.

The load distribution device is provided with a function of specifying a user identifier such as a contractor number or telephone number from a source IP address used by the user in making communication, and transferring the traffic based on the user identifier.

Also, the band control device is provided with a function of managing the traffic for each user identifier, and making the band control of traffic through a transparent process installed on the network path and not recognized by the originator and recipient of the communication.

According to the invention, a band control system comprises, for example,

a load distribution device for transferring the traffic by selecting one of a plurality of candidates at the time of transferring the traffic,

a band control device for managing the traffic for each user identifier, and making the band management of traffic, and

a user management device for managing the correspondence between the IP address that is the identifier of a network and the user identifier of the user using the network,

wherein

the load distribution device acquires the correspondence of the user identifier from the IP address of the traffic to be processed using the user management device in transferring the traffic, and transfers the traffic based on the user identifier,

the band control device manages the traffic for each user identifier and makes the band control of traffic through a transparent process installed on the network path and not recognized by the originator and recipient of the communication,

the load distribution device distributes the traffic for each user identifier, and the band control device makes the band control for each user.

Also, the load distribution device specifies the user identifier from the user management device from the source IP address used by the user in making the communication, and transfers the traffic based on the user identifier.

Also, the band control device specifies the user identifier from the user management device from the source IP address used by the user in making the communication, manages the traffic for each user identifier, and makes the band control of traffic through a transparent process installed on the network path and not recognized by the originator and recipient of the communication.

According to the first solving means of the present invention, there is provided a band control system comprising:

a first user terminal having a first source address used by a user;

a second user terminal having a second source address used by the user;

a plurality of band control devices, each having a band control management information table storing an upper-limit band value and a used band value associated with a user identifier that is an identifier of the user, for managing the used band of traffic by monitoring the traffic for each user identifier;

a first load distribution device connected to the first and second user terminals via one or more networks, having a first allocation table storing a band control device identifier associated with the user identifier, and transferring the traffic by selecting one of the plurality of band control devices in transferring the traffic; and

a user management device for managing the correspondence between the first source address and the user identifier, with a user connection management information table storing the same user identifier corresponding to each of the first source address of the first user terminal and the second source address of the second user terminal, which are used by the user,

wherein

the first load distribution device makes an inquiry to the user management device about the traffic received from the first user terminal, using the first source address included in the traffic,

the user management device makes a response with the user identifier designating the user corresponding to the first source address by referring to the user connection management information table for the first source address on the inquiry of the first load distribution device,

the first load distribution device acquires a band control device identifier to be allocated by referring to the first allocation table based on the user identifier of the user obtained from the user management device, and transfers the traffic to the band control device to be allocated,

the band control device makes an inquiry to the user management device about the traffic received from the first load distribution device, using the first source address included in the traffic, and

the user management device makes a response with the user identifier designating the user corresponding to the first source address by referring to the user connection management information table for the first source address on the inquiry of the band control device,

on the other hand,

the first load distribution device makes an inquiry to the user management device about the traffic received from the second user terminal, using the second source address included in the traffic,

the user management device makes a response with the user identifier designating the user corresponding to the second source address by referring to the user connection management information table for the second source address on the inquiry of the first load distribution device,

the first load distribution device acquires a band control device identifier to be allocated by referring to the first allocation table based on the user identifier of the user obtained from the user management device, and transfers the traffic to the band control device to be allocated,

the band control device makes an inquiry to the user management device about the traffic received from the first load distribution device, using the second source address included in the traffic, and

the user management device makes a response with the user identifier designating the user corresponding to the second source address by referring to the user connection management information table for the second source address on the inquiry of the band control device, and

thereby,

the band control device manages the traffic by storing, for each user identifier, a used band value due to both of the traffic from the first and second user terminals used by the user in the band control management information table in accordance with the user identifier obtained from the user management device, and, by referring to the band control management information table in accordance with the user identifier for the received traffic from the first or second user terminals of the user, performs a traffic suppression process to control the used band of the user if the user band value of the user reaches an upper-limit band value, or performs a traffic transfer process if the user band value of the user does not reach the upper-limit band value.

According to the second solving means of the present invention, there is provided a load distribution device in a band control system, the band control system comprising:

a first user terminal having a first source address used by a user;

a second user terminal having a second source address used by the user;

a plurality of band control devices, each having a band control management information table storing an upper-limit band value and a used band value associated with a user identifier that is an identifier of the user, for managing the used band of traffic by monitoring the traffic for each user identifier; and,

a user management device for managing the correspondence between the first source address and the user identifier, with a user connection management information table storing the same user identifier corresponding to each of the first source address of the first user terminal and the second source address of the second user terminal, which are used by the user,

the load distribution device, which is connected to the first and second user terminals via one or more networks, comprising:

a first allocation table storing a band control device identifier associated with the user identifier; and

a load distribution processing section for transferring the traffic by selecting one of the plurality of band control devices in transferring the traffic;

wherein

the load distribution processing section makes an inquiry to the user management device about the traffic received from the first user terminal, using the first source address included in the traffic,

the load distribution processing section receives, from the user management device, the user identifier designating the user corresponding to the first source address,

the load distribution processing section acquires a band control device identifier to be allocated by referring to the first allocation table based on the user identifier of the user obtained from the user management device, and transfers the traffic to the band control device to be allocated,

on the other hand,

the load distribution processing section makes an inquiry to the user management device about the traffic received from the second user terminal, using the second source address included in the traffic,

the load distribution processing section receives, from the user management device, the user identifier designating the user corresponding to the second source address,

the load distribution processing section acquires a band control device identifier to be allocated by referring to the first allocation table based on the user identifier of the user obtained from the user management device, and transfers the traffic to the band control device to be allocated,

thereby,

the band control device manages, for each user identifier, a used band value due to both of the traffic from the first and second user terminals used by the user in accordance with the user identifier obtained from the user management device, and, in accordance with the user identifier for the traffic from the first or second user terminals of the user, performs a traffic suppression process to control the used band of the user if the user band value of the user reaches an upper-limit band value, or performs a traffic transfer process if the user band value of the user does not reach the upper-limit band value.

According to the third solving means of the present invention, there is provided a band control device in a band control system, the a band control system comprising:

a first user terminal having a first source address used by a user;

a second user terminal having a second source address used by the user;

a plurality of band control devices,

a load distribution device connected to the first and second user terminals via one or more networks, having a first allocation table storing a band control device identifier associated with the user identifier, and transferring the traffic by selecting one of the plurality of band control devices in transferring the traffic; and

a user management device for managing the correspondence between the first source address and the user identifier, with a user connection management information table storing the same user identifier corresponding to each of the first source address of the first user terminal and the second source address of the second user terminal, which are used by the user,

each of the band control device comprising:

a band control management information table storing an upper-limit band value and a used band value associated with a user identifier that is an identifier of the user; and

a band control processing section for managing the used band of traffic by monitoring the traffic for each user identifier,

wherein

the band control processing section makes an inquiry to the user management device about the traffic received from the load distribution device, using the first source address included in the traffic, and

the band control processing section receives, from the user management device, the user identifier designating the user corresponding to the first source address,

on the other hand,

the band control processing section makes an inquiry to the user management device about the traffic received from the load distribution device, using the second source address included in the traffic, and

the band control processing section receives, from the user management device, the user identifier designating the user corresponding to the second source address

thereby,

the band control processing section manages the traffic by storing, for each user identifier, a used band value due to both of the traffic from the first and second user terminals used by the user in the band control management information table in accordance with the user identifier obtained from the user management device, and, by referring to the band control management information table in accordance with the user identifier for the received traffic from the first or second user terminals of the user, performs a traffic suppression process to control the used band of the user if the user band value of the user reaches an upper-limit band value, or performs a traffic transfer process if the user band value of the user does not reach the upper-limit band value.

With the invention, in a case where a plurality of band control devices are required due to increased traffic, and under the condition where the user uses a plurality of terminals to generate a plurality of communications at the same time, it is possible to manage the traffic for each user and make the band control.

As a result, it is possible to suppress the use of the heavy user occupying the network facilities, and realize the fair use of the network without imposing load on general users.

### BRIEF DESCRIPTION OF THE DRAWINGS

FIG. 1 is a configuration diagram of a band control system according to an embodiment of the invention.

FIG. 2 is a view showing an organization example of an allocation table.

FIG. 3 is a view showing an organization example of a band control management information table.

FIG. 4 is a view showing an organization example of a user connection management information table.

FIG. 5 is a flowchart of a load distribution device.

FIG. 6 is a flowchart of a band control device.

### DESCRIPTION OF THE PREFERRED EMBODIMENTS

An embodiment of the invention will be described below with reference to the drawings.

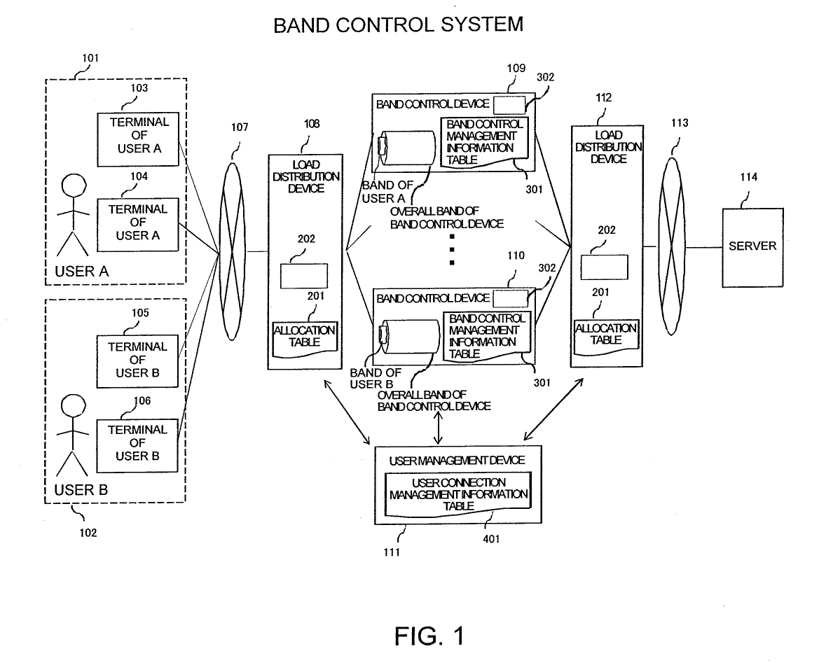

FIG. 1 is a diagram showing one configuration example of a band control system according to the embodiment of the invention.

In the example of FIG. 1, a user A 101 possesses a terminal 103 of a user A and a terminal 104 of the user A, and a user B 102 possesses a terminal 105 of a user B and a terminal 106 of the user B. Communication can be made from each terminal through a mobile communication network 107, a system according to this embodiment and an internet 113 to a server 114.

Also, the system according to this embodiment comprises a load distribution device 108, a load distribution device 112, a band control device 109, a band control device 110, and a user management device 111.

The load distribution device 108 comprises an allocation table 201 for uniquely managing the band control device that transfers traffic to a user identifier, and a load distribution processing part 202 for transferring the traffic by selecting one of a plurality of band control devices 110 in transferring the traffic. The load distribution device 112, like the load distribution device 108, has the allocation table 201. The allocation tables 201 provided for both the band control devices 109 and 110 are organized to pre-store the same contents if the same band control device 109 is used in the upstream and downstream transmission. Also, if the different band control devices 109 are used in the upstream and downstream transmission, they may be organized to pre-store the different contents.

The band control device 109 comprises a band control management information table 301 for managing the communication band for each user identifier with the traffic passed through the band control device 109, and a band control processing part 302 for monitoring the traffic for each user identifier and managing the used band of traffic. The band control device 110, like the band control device 109, has the band control management information table 301. The band control management information table 301 provided for each band control device 109 can be organized to pre-store the same contents. The data of the band control management information table 301 for each band control device 109 may be set to the same contents at a proper timing such as at a predetermined period or when data is changed by the user management device 111 or any other device, not shown. Also, an upper-limit band value may be pre-stored by a maintenance terminal or any other device, with a user identifier 201A set to a user identifier 301A, in the band control management information table 301 for the band control device 109 corresponding to a band control device identifier 201B in accordance with data set in the allocation table 201.

The user management device 111 has a user connection management information table 401 for managing a terminal identifier corresponding to the IP address and the user identifier corresponding to the terminal identifier.

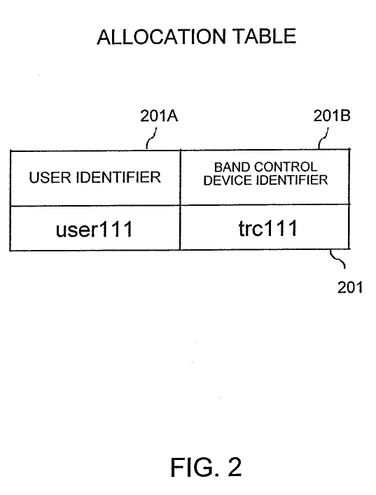

FIG. 2 is an explanatory view showing an organization example of the allocation table. The allocation table 201 has table information describing the band control device identifier 201B associated with the user identifier 201A.

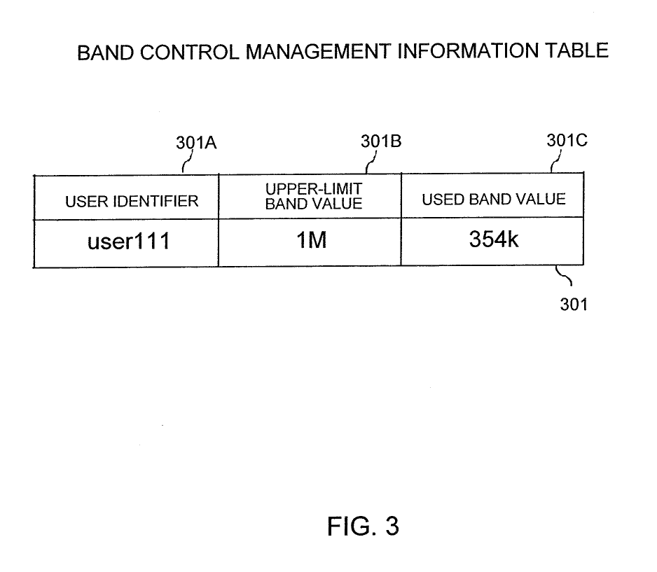

FIG. 3 is an explanatory view showing an organization example of the band control management information. The band control management information table 301 is a table storing the user identifier 301A, an upper-limit band value 301B and a used band value 301C which are associated with one another.

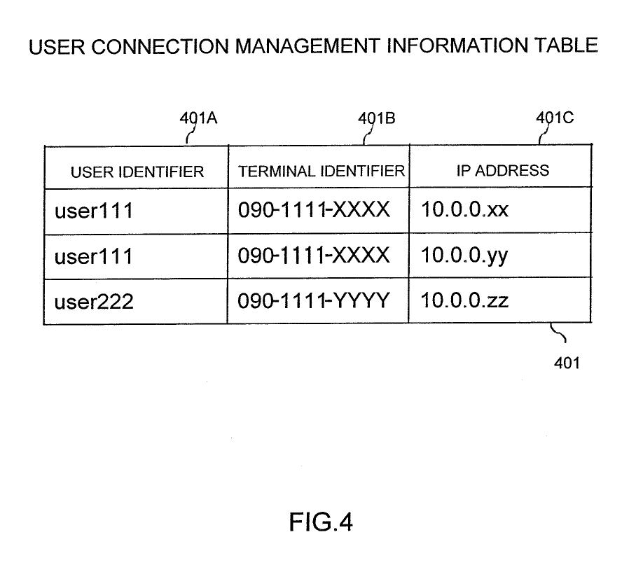

FIG. 4 is an explanatory view showing an organization example of the user connection management information. The user connection management information table 401 is a table storing a user identifier 401A, a terminal identifier 401B and a source IP address 401C which are associated with one another.

The operation of the system will be described below.

### (1) Upstream Direction

(Call Origination from the Terminal 103 of the User A)

For example, when communication is made from the terminal 103 of the user A possessed by the user A 101 to the server 104, traffic occurring from the terminal 103 of the user A passes through the mobile communication network 107 to arrive at the load distribution device 108. This traffic includes the source IP address and the destination IP address.

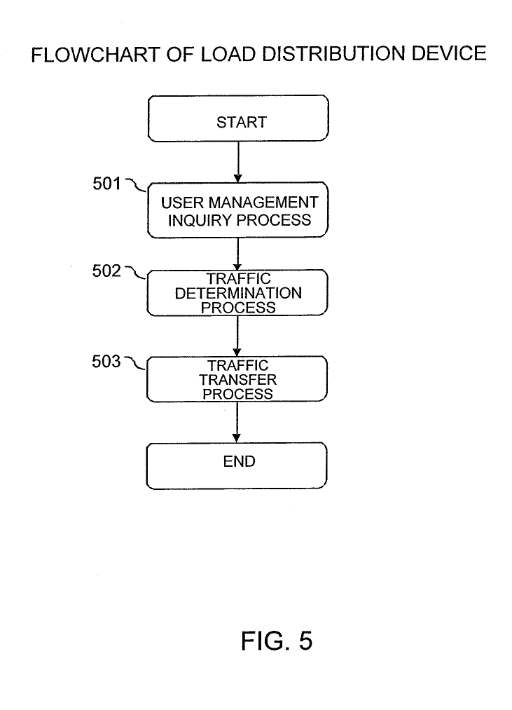

FIG. 5 is a flowchart of the load distribution device. The load distribution device 108 (load distribution processing part 202) performs a user management inquiry process (501) to the user management device 111 about the traffic received from the terminal 103 of the user A, using the source IP address (e.g., 10.0.0.xx) included in the traffic. The user management device 111 replies with the user identifier 401A (e.g., user111) designating the user A 101 that is the user corresponding to the source IP address 401C by referring to the user connection management information table 401 for the source IP address on the inquiry content of the load distribution device 108 (load distribution processing part 202). The load distribution device 108 (load distribution processing part 202) performs a traffic determination process (502) in reply to the user management device 111, to identify that the traffic is a traffic occurring from the user A 101. The load distribution device 108 (load distribution processing part 202) performs a traffic transfer process (503) for the band control device 109 to be allocated by referring to the allocation table 201 to associate the user identifier 201A of the user A 101 with the band control device identifier 201B (e.g., trc111) to be allocated.

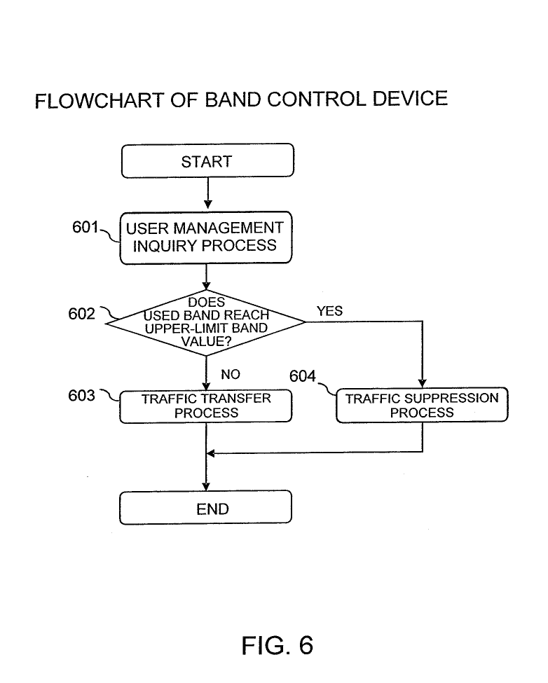

FIG. 6 is a flowchart of the band control device. The band control device 109 (band control processing part 302) performs a user management inquiry process (601) for the user management device 111 about the received traffic. The user management device 111 replies with the user identifier 401A (e.g., user111) designating the user A 101 that is a user corresponding to the source IP address 401C by referring to the user connection management information table 401 for the source IP address of the inquiry content of the load distribution device 108. The load control device 109 (band control processing part 302) obtains the identifier 401A (e.g., user111) of the user A 101 corresponding to the source IP address 401C (e.g., 10.0.0.xx) of traffic. The band control device 109 (band control processing part 302) manages the traffic used by the user A 101 in the band control management information table 301, monitors (602) the used band value for each user identifier 301A (e.g., user111), and stores the value in the used band value 301C at a proper timing. Also, the band control device 109 (band control processing part 302) performs a traffic suppression process (603) to restrict the used band of the user A 101 if the user band value 301C reaches the upper-limit band value 301B. The band control device 109 performs a traffic transfer process (604) to lead through the load distribution device 112 and the internet 113 to the server 114 if the user band value does not reach the upper-limit band value 301B.

(Call Origination from the Terminal 104 of the User A)

Similarly, in the case where communication is made from the terminal 104 of the user A possessed by the user A 101 to the server 104, traffic occurring from the terminal 103 of the user A passes through the mobile communication network 107 to arrive at the load distribution device 108.

The load distribution device 108 (load distribution processing part 202) performs a user management inquiry process (501) for the user management device 111 about the traffic received from the terminal 104 of the user A, using the source IP address (e.g., 10.0.0.yy) included in the traffic, as shown in FIG. 5. The user management device 111 replies with the user identifier 401A (e.g., user111) designating the user A 101 that is a user corresponding to the source IP address 401C by referring to the user connection management information table 401 for the source IP address of the inquiry content of the load distribution device 108 (load distribution processing part 202). The load distribution device 108 (load distribution processing part 202) performs a traffic transfer process (503) for the band control device 109 to be allocated by referring to the allocation table 201 to associate the user identifier 201A of the user A 101 with the band control device identifier 201B (e.g., trc111) to be allocated.

Also, the band control device 109 performs a user management inquiry process (601) for the user management device 111 about the received traffic, as shown in FIG. 6. The user management device 111 replies with the user identifier 401A (e.g., user111) designating the user A 101 that is a user corresponding to the source IP address 401C by referring to the user connection management information table 401 for the source IP address of the inquiry content of the load distribution device 108. The band control device 109 (band control processing part 302) obtains the identifier 401A (e.g., user111) of the user A 101 corresponding to the source IP address 401C (e.g., 10.0.0.yy) of traffic. The band control device 109 (band control processing part 302) manages the traffic used by the user A 101 in the band control management information table 301, monitors (602) the used band value for each user identifier 301A (e.g., user111), and stores the value in the used band value 301C at a proper timing. That is, the band control device 109 (band control processing part 302) calculates a total of user band values for communication with a plurality of terminals used by the user A such as user terminal 103 and user terminal 104, and stores it in the used band value 301C of the band control management information table 301. Also, the band control device 109 (band control processing part 302) performs the traffic suppression process (603) if the used band value 301C reaches the upper-limit band value 301B, or performs the traffic transfer process (604) if the used band value does not reach the upper-limit band value 301B.

In this way, when the user A 101 uses the terminal 104 of the user A, the load distribution device 108 and the load distribution device 112 similarly perform the process with the same user identifier as the terminal 103 of the user A from the user management device 111, whereby the user A 101 always involves one station management for the band with one band control device 109 to distribute the traffic to the band control device 109.

### (2) Downstream Direction

The traffic from the server 114 to the terminal 103 or 104 of the user A is passed through the internet 113, subjected to the same process in the load distribution device 112 as that in the load distribution device 108, and distributed to the band control device 109. Herein, the band control device 109 further comprises a band control management information table for downstream communication. Also, on the inquiry for the user identifier, the IP address of the terminal 103 or 104 of the user, namely, destination IP address is used instead of the source IP address. The band control device 109 makes the band control with the upper-limit band value assigned to each user based on the band control management information, and the traffic is transmitted through the load distribution device 108 and the mobile communication network 107 to the terminal 103 or 104 of the user A, as described above.

The user terminals 103 and 104 may be constructed as an integral device or separate devices.

The load distribution device may be interposed only upstream from the user to the server, only downstream from the server to the user, or both upstream and downstream.

The user terminals 103 and 104 may be connected from the different networks to the load distribution device.

What is claimed is:

1. A band control system comprising:
a first user terminal having a first source address used by a user;
a second user terminal having a second source address used by the user;
a plurality of band control devices, each having a band control management information table storing an upper-limit band value and a used band value associated with a user identifier that is an identifier of the user, for managing the used band of traffic by monitoring the traffic for each user identifier;
a first load distribution device connected to the first and second user terminals via one or more networks, having a first allocation table storing a band control device identifier associated with the user identifier, and transferring the traffic by selecting one of the plurality of band control devices in transferring the traffic; and
a user management device for managing the correspondence between the first source address and the user identifier, with a user connection management information table storing the same user identifier corresponding to each of the first source address of the first user terminal and the second source address of the second user terminal, which are used by the user,
wherein
the first load distribution device makes an inquiry to the user management device about the traffic received from the first user terminal, using the first source address included in the traffic,
the user management device makes a response with the user identifier designating the user corresponding to the first source address by referring to the user connection management information table for the first source address on the inquiry of the first load distribution device,
the first load distribution device acquires a band control device identifier to be allocated by referring to the first allocation table based on the user identifier of the user obtained from the user management device, and transfers the traffic to the band control device to be allocated,
the band control device makes an inquiry to the user management device about the traffic received from the first load distribution device, using the first source address included in the traffic, and
the user management device makes a response with the user identifier designating the user corresponding to the first source address by referring to the user connection management information table for the first source address on the inquiry of the band control device,
on the other hand,
the first load distribution device makes an inquiry to the user management device about the traffic received from the second user terminal, using the second source address included in the traffic,
the user management device makes a response with the user identifier designating the user corresponding to the second source address by referring to the user connection management information table for the second source address on the inquiry of the first load distribution device,
the first load distribution device acquires a band control device identifier to be allocated by referring to the first allocation table based on the user identifier of the user obtained from the user management device, and transfers the traffic to the band control device to be allocated,
the band control device makes an inquiry to the user management device about the traffic received from the first load distribution device, using the second source address included in the traffic, and
the user management device makes a response with the user identifier designating the user corresponding to the second source address by referring to the user connection management information table for the second source address on the inquiry of the band control device, and
thereby,
the band control device manages the traffic by storing, for each user identifier, a used band value due to both of the traffic from the first and second user terminals used by the user in the band control management information table in accordance with the user identifier obtained from the user management device, and, by referring to the band control management information table in accordance with the user identifier for the received traffic from the first or second user terminals of the user, performs a traffic suppression process to control the used band of the user if the user band value of the user reaches an upper-limit band value, or performs a traffic transfer process if the user band value of the user does not reach the upper-limit band value.

2. A band control system according to claim 1 further comprising:
a second load distribution device connected to the plurality of band control devices, having a second allocation table storing a band control device identifier associated with the user identifier, and transferring the traffic by selecting one of the plurality of band control devices in transferring the traffic; and
a server connected to the second load distribution device via one or more networks;
wherein
each of the plurality of band control devices, having a band control management information table for downstream traffic storing an upper-limit band value and a used band value associated with a user identifier that is an identifier of the user, for managing the used band of traffic by monitoring the traffic for each user identifier;
the second load distribution device makes an inquiry to the user management device about the traffic received from the first user terminal, using the first destination address included in the traffic,
the user management device makes a response with the user identifier designating the user corresponding to the first destination address by referring to the user connection management information table for the first destination address on the inquiry of the second load distribution device,
the second load distribution device acquires a band control device identifier to be allocated by referring to the second allocation table based on the user identifier of the user obtained from the user management device, and transfers the traffic to the band control device to be allocated,
the band control device makes an inquiry to the user management device about the traffic received from the second load distribution device, using the first destination address included in the traffic, and
the user management device makes a response with the user identifier designating the user corresponding to the first destination address by referring to the user connection management information table for the first destination address on the inquiry of the band control device,
the band control device manages the traffic by storing, for each user identifier, a used band value used by the user in the band control management information table for downstream traffic in accordance with the user identifier obtained from the user management device, and, by referring to the band control management information table for downstream traffic in accordance with the user identifier for the received traffic from the user, performs a traffic suppression process to control the used band of the user if the user band value of the user reaches an upper-limit band value, or performs a traffic transfer process if the user band value of the user does not reach the upper-limit band value.

3. The band control system according to claim 1, wherein the band control management information table for each of the plurality of band control devices is synchronized to store the same contents.

4. The band control system according to claim 3, further comprising a control device for synchronizing the storage contents of the band control management information table.

5. The band control system according to claim 2, wherein the first allocation table and the second allocation table store the same contents to allocate the same band control device in upstream and downstream directions for each user.

6. The band control system according to claim 2, wherein the first allocation table and the second allocation table store different contents to allocate different specific band control devices in upstream and downstream directions for each user.

7. The band control system according to claim 1, wherein the first user terminal and the second user terminal are provided within one device.

8. A load distribution device in a band control system, the band control system comprising:
a first user terminal having a first source address used by a user;
a second user terminal having a second source address used by the user;
a plurality of band control devices, each having a band control management information table storing an upper-limit band value and a used band value associated with a user identifier that is an identifier of the user, for managing the used band of traffic by monitoring the traffic for each user identifier; and,
a user management device for managing the correspondence between the first source address and the user identifier, with a user connection management information table storing the same user identifier corresponding to each of the first source address of the first user terminal and the second source address of the second user terminal, which are used by the user,
the load distribution device, which is connected to the first and second user terminals via one or more networks, comprising:
a first allocation table storing a band control device identifier associated with the user identifier; and
a load distribution processing section for transferring the traffic by selecting one of the plurality of band control devices in transferring the traffic;
wherein
the load distribution processing section makes an inquiry to the user management device about the traffic received from the first user terminal, using the first source address included in the traffic,
the load distribution processing section receives, from the user management device, the user identifier designating the user corresponding to the first source address,
the load distribution processing section acquires a band control device identifier to be allocated by referring to the first allocation table based on the user identifier of the user obtained from the user management device, and transfers the traffic to the band control device to be allocated,
on the other hand,
the load distribution processing section makes an inquiry to the user management device about the traffic received from the second user terminal, using the second source address included in the traffic,
the load distribution processing section receives, from the user management device, the user identifier designating the user corresponding to the second source address,
the load distribution processing section acquires a band control device identifier to be allocated by referring to the first allocation table based on the user identifier of the user obtained from the user management device, and transfers the traffic to the band control device to be allocated,
thereby,
the band control device manages, for each user identifier, a used band value due to both of the traffic from the first and second user terminals used by the user in accordance with the user identifier obtained from the user management device, and, in accordance with the user identifier for the traffic from the first or second user terminals of the user, performs a traffic suppression process to control the used band of the user if the user band value of the user reaches an upper-limit band value, or performs a traffic transfer process if the user band value of the user does not reach the upper-limit band value.

9. A band control device in a band control system, the a band control system comprising:
a first user terminal having a first source address used by a user;
a second user terminal having a second source address used by the user;
a plurality of band control devices,
a load distribution device connected to the first and second user terminals via one or more networks, having a first allocation table storing a band control device identifier associated with the user identifier, and transferring the traffic by selecting one of the plurality of band control devices in transferring the traffic; and
a user management device for managing the correspondence between the first source address and the user identifier, with a user connection management information table storing the same user identifier corresponding to each of the first source address of the first user terminal and the second source address of the second user terminal, which are used by the user,
each of the band control device comprising:
a band control management information table storing an upper-limit band value and a used band value associated with a user identifier that is an identifier of the user; and
a band control processing section for managing the used band of traffic by monitoring the traffic for each user identifier,
wherein
the band control processing section makes an inquiry to the user management device about the traffic received from the load distribution device, using the first source address included in the traffic, and
the band control processing section receives, from the user management device, the user identifier designating the user corresponding to the first source address,
on the other hand,
the band control processing section makes an inquiry to the user management device about the traffic received from the load distribution device, using the second source address included in the traffic, and
the band control processing section receives, from the user management device, the user identifier designating the user corresponding to the second source address
thereby,
the band control processing section manages the traffic by storing, for each user identifier, a used band value due to both of the traffic from the first and second user terminals used by the user in the band control management information table in accordance with the user identifier obtained from the user management device, and, by referring to the band control management information table in accordance with the user identifier for the received traffic from the first or second user terminals of the user, performs a traffic suppression process to control the used band of the user if the user band value of the user reaches an upper-limit band value, or performs a traffic transfer process if the user band value of the user does not reach the upper-limit band value.

10. The band control device in the band control system according to claim 9, wherein the band control management information table for each of the plurality of band control devices is synchronized to store the same contents.

11. The band control device in the band control system according to claim 10, further comprising a control device for synchronizing the storage contents of the band control management information table.
